(19) United States
(12) Patent Application Publication
(10) Pub. No.: US 2009/0210476 A1
(43) Pub. Date: Aug. 20, 2009

(54) SYSTEM AND METHOD FOR PROVIDING TANGIBLE FEEDBACK ACCORDING TO A CONTEXT AND PERSONALITY STATE

(76) Inventors: Joseph Arie Levy, Givatayim (IL); Doron Frenkel, Kfar-Sava (IL); Doron Zohar, Kfar-Hess (IL)

Correspondence Address: Pearl Cohen Zedek Latzer, LLP, 1500 Broadway, 12th Floor, New York, NY, 10036, US

(21) Appl. No.: 12/033,107

(22) Filed: Feb. 19, 2008

(51) Int. Cl. G06F 3/01; G06F 15/16

(52) U.S. Cl. 709/201; 715/700

(57) ABSTRACT

A system and method for maintaining a personality and an associated state and further causing an apparatus to perform tangible actions according to a personality, a state and a context. Embodiments of the invention may compute a state of a personality and a context according to detected events and input obtained. A state may further be computed according to a maintained context. An apparatus may be commanded to perform actions reflecting a computed state and context. Other embodiments are described and claimed.

### BACKGROUND OF THE INVENTION

Computer applications and peripheral devices aimed at enabling a user to interact with computerized systems are constantly evolving. Various methods, applications and/or devices are being developed in order to expand and increase ways by which users can provide input to such systems and further be provided with output and feedback. Means of providing output to users include, for example, visual effects and/or audio effects. Other than traditional peripherals such as display and speakers, feedback to users of a computer may be provided by mechanical devices. For example, mechanical devices controlled by a computer program may provide various feedback to a computer user. For example, a mechanical device may be commanded to perform mechanical motion in order to convey a message, feeling and/or emotion or other information to a user.

Sources of information provided to a user may vary as well as events that may trigger a system to provide output or feedback to a user. For example, a computer may display a warning message on a computer display when an application crashes or a computer may play a predefined audio file when a new electronic mail message is received.

Output and/or feedback provided by a computerized system to a user may vary in nature and may be based on various levels of processing of information. For example, an application may play a predefined sound when a specific text or icon is received over a chat session. However, there is a need for output and/or feedback provided by a computerized system to a user that is based on a personality, a state of a personality and a context.

### SUMMARY OF EMBODIMENTS OF THE INVENTION

Embodiments of the invention may maintain a personality and an associated state. Embodiments of the invention may further compute a state of a personality and a context according to detected events and obtained information. A state may further be computed according to a maintained context. An apparatus may be configured and commanded to perform gestures and/or actions reflecting a computed state and a computed context.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1A shows an exemplary high-level diagram of exemplary components according to embodiments of the present invention;

FIG. 1B shows an exemplary high-level diagram of exemplary components according to embodiments of the present invention;

FIG. 2 shows an exemplary high-level diagram of exemplary components according to embodiments of the present invention; and

FIG. 3 is a flowchart according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

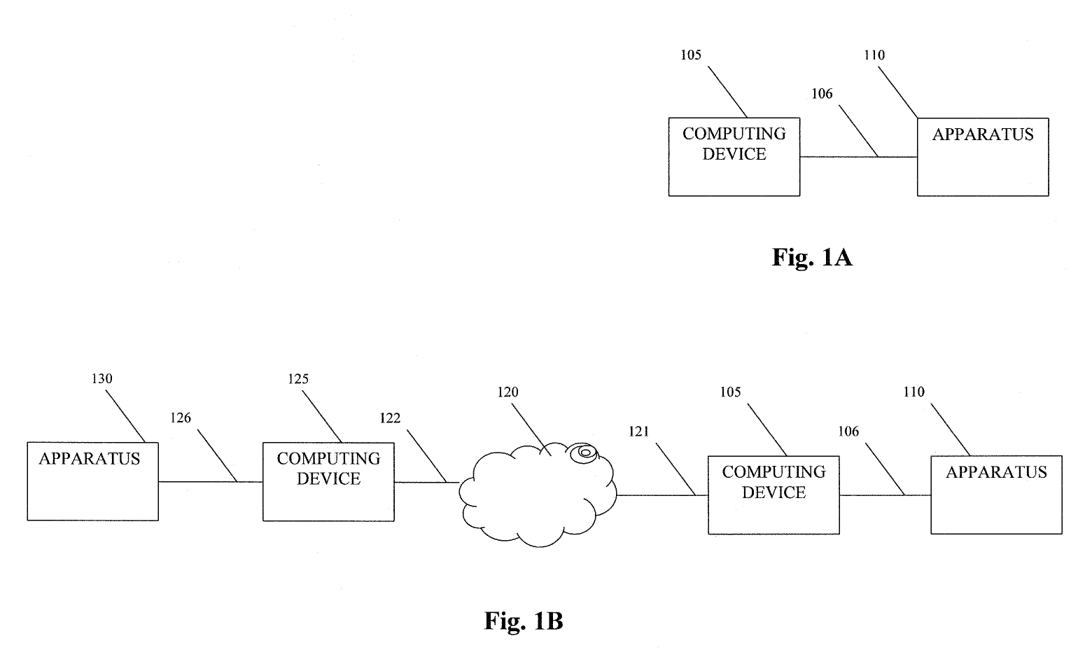

Reference is made to FIG. 1A showing an exemplary high level diagram of exemplary components according to embodiments of the invention. According to embodiments of the invention, computing device 105 may include components such as, but not limited to, a plurality of central processing units (CPU) or any other suitable multi-purpose or specific processors or controllers, a plurality of input units, a plurality of output units, a plurality of memory units, and a plurality of storage units. Computing device 105 may additionally include other suitable hardware components and/or software components. In some embodiments, computing device 105 may include or may be, for example, a personal computer, a desktop computer, a mobile computer, a laptop computer, a notebook computer, a terminal, a workstation, a server computer, a Personal Digital Assistant (PDA) device, a tablet computer, a network device, a mobile phone, a household appliance or any other suitable computing device with which a user may possibly interact.

According to embodiments of the invention, apparatus 110 may be of various size and/or shape. Apparatus 110 may further comprise various mechanical, electrical and/or any other applicable physical components, attributes and aspects. For example, apparatus 110 may be able to execute mechanical motions, e.g., move, either as a whole or, alternatively, move some connected parts. Apparatus 110 may further comprise a face and limbs and may further be capable of producing effects such as moving hands, dance, flicker eyes, move mouth etc. Apparatus 110 may further emit light, produce sound or perform any other suitable tangible effects e.g., flash lights, talk, play music or present video clips on a suitably mounted display.

According to embodiments of the invention, apparatus 110 may be equipped with various input means. For example, apparatus 110 may comprise audio sensing devices such as a microphone, or light sensing device such as a camera. Apparatus 110 may further comprise mechanical input means, for example, one or more buttons, possibly hidden, may be installed on apparatus 110 where pressing such buttons may cause apparatus 110 to perform an action. For example, such action may be a mechanical movement or other effects such as described above or an action may be a communication of information, for example, a communication of information to computing device 105.

According to embodiments of the invention, apparatus 110 may use various sources of energy in order to operate. For example, apparatus 110 may use solar energy, heat energy or any other suitable and/or applicable sources of energy. According to embodiments of the invention, apparatus 110 may use electrical energy. For example, apparatus 110 may be equipped with electrical batteries that may provide it with electric energy. Such batteries may be charged by various means, for example, by a dedicated line that may connect apparatus 110 to an electrical source. According to embodiments of the invention, such source may be computing device 105.

According to embodiments of the invention, communication medium 106 may be any suitable communication medium. For example, communication medium 106 may be a wireless communication infrastructure such as, for example, bluetooth, a ZigBee infrastructure (ZigBee is a specification set built around the Institute of Electrical and Electronics Engineers (IEEE) 802.15.4 wireless protocol), a proprietary radio frequency (RF) protocol, a wireless fidelity (WiFi) communication infrastructure or it may be an infra red communication infrastructure, e.g., infrared data association (IrDA). According to embodiments of the invention, communication medium 106 may alternatively be a wired communication medium such as serial, parallel, coax or universal serial bus (USB) communication medium. According to some embodiments of the invention, medium 106 may further provide apparatus 110 with electric power.

According to embodiments of the invention, computing device 105 may be capable of communicating information to apparatus 110, possibly over communication medium 106. For example, computing device 105 may communicate commands to apparatus 110. Such commands may further cause apparatus 110 to perform various mechanical, visual, audio or other operations and/or effects. For example, apparatus 110 may perform mechanical movements according to one or more commands received from computing device 105 or apparatus 110 may play a sound or emit light in response to one or more commands received from computing device 105. According to embodiments of the invention, apparatus 110 may be capable of communicating information to computing device 105, possibly over communication medium 106. According to embodiments of the invention, information communicated by apparatus 110 to computing device 105 may comprise various information. For example, information communicated by apparatus 110 to computing device 105 may comprise information obtained by various input devices that apparatus 110 may be equipped with. Such devices may be, for example, light sensing devices, audio sensing devices and/or mechanical devices such as buttons or micro switches.

Reference is made to FIG. 1B showing an exemplary high level diagram of exemplary components according to embodiments of the invention. According to embodiments of the invention, computing device 105 may be connected to a network such as network 120. According to embodiments of the invention, network 120 may be a private internet protocol (IP) network, a public IP network such as the internet. Network 120 may further comprise integrated services digital network (ISDN) lines, frame relay connections, and/or network 120 may comprise a modem connected to a phone line or any other suitable communication means. Network 120 may further be or comprise a public switched telephone network (PSTN), any public or private data network, a local area network (LAN), a metropolitan area network (MAN), a wide area network (WAN), a wireline or wireless network, a local, regional, or global communication network, an enterprise intranet or any combination of the preceding.

According to embodiments of the invention, computing device 125 may be similar to computing device 105, namely, computing device 125 may comprise any components and/or aspects as described above with reference to computing device 105. Accordingly, apparatus 130 may be similar to apparatus 110 and communication medium 126 may be similar to communication medium 106. According to embodiments of the invention, communication mediums 121 and 122 may be any suitable communication mediums capable of operatively connecting computing devices 105 and 125 to network 120 and further enabling computing devices 105 and 125 to communicate any applicable information over network 120. For example, communication mediums 121 and 122 may be a wireless communication infrastructure such as, for example, a bluetooth or a WiFi communication infrastructures or they may be an infrared communication infrastructures, e.g., IrDA. According to embodiments of the invention, communication mediums 121 and 122 may alternatively be any suitable wired communication medium such as serial, parallel, coax or universal serial bus (USB) communication medium.

According to embodiments of the invention, a computing device such as, for example, computing device 105, may communicate with a remote apparatus, for example apparatus 130, over a network. According to embodiments of the invention, a first computing device may communicate commands and/or information to a second computing device and the second computing device may further communicate such commands and/or information to a directly attached apparatus. For example, computing device 125 may communicate information destined to apparatus 110 to computing device 105. Computing device 105 may further communicate such information to apparatus 110. It should be noted that although only two configurations of a computing device and an attached apparatus are shown in FIG. 1B, embodiments of the invention are not limited in the number of such configurations attached to a network and further capable of intercommunicating as described. It should also be noted that according to embodiments of the invention, a computing device such as computing device 105 may be operatively connected to any suitable number of apparatuses such as apparatus 110.

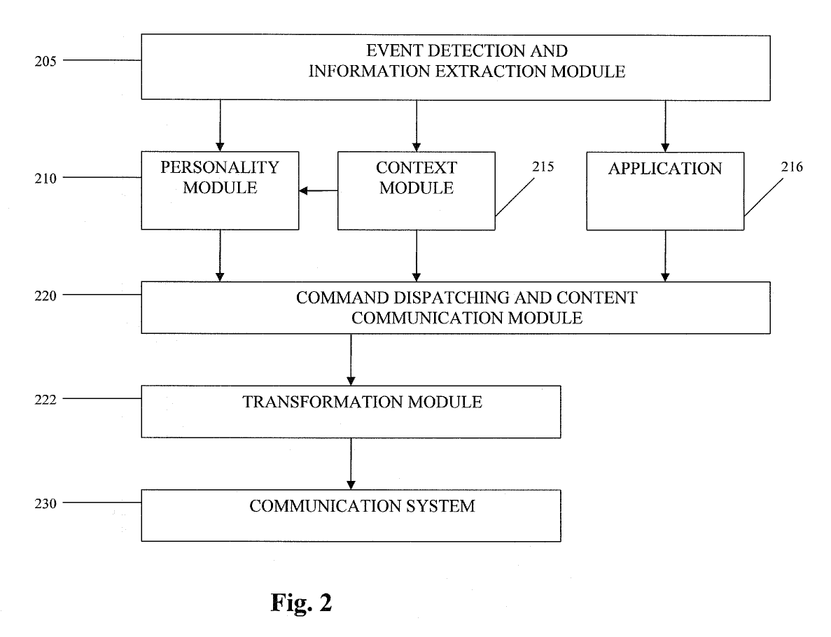

Reference is made to FIG. 2 showing an exemplary, high level diagram of exemplary components according to embodiments of the invention. According to embodiments of the invention components shown in FIG. 2 may be installed in a computing device such as computing device 105 or 125. According to embodiments of the invention, components shown in FIG. 2 may be implemented by software, hardware, firmware or any combination thereof. According to embodiments of the invention and as shown by block 205, embodiments of the invention may comprise an event detection and information extraction module. According to embodiments of the invention, module 205 may detect various software and/or hardware events. For example, module 205 may detect any applicable event pertaining to a specific application. For example, an arrival of a new message over a session associated with an IM application or an arrival of a new electronic mail message. According to embodiments of the invention, module 205 may be further configured to intercept, get, read or otherwise obtain information pertaining to an event. For example, content communicated in a message over a session associated with an instant messaging (IM) application or a content included in an electronic mail message may be made available to module 205. Module 205 may further be configured to communicate such obtained information, for example to module 210 and/or module 215. Module 205 may communicate such information with an indication and/or parameters pertaining to an event associated with such information.

According to embodiments of the invention, module 205 may be configured to receive any applicable indication of an occurrence of an event and/or associated information from an operating system operating a computing device such as devices 105 and/or 125. For example, module 205 may be informed of events such as, but not limited to, a connect or disconnect of various hardware devices, an invocation of an application, a problem or fault pertaining to an application, software, hardware or firmware, a network connection state change, a shutdown procedure initiation etc. According to embodiments of the invention, module 205 may further detect or otherwise be informed of events such as, a disk capacity threshold or limitation being crossed or violated or a CPU usage threshold or limitation being crossed or violated and/or any, possibly preconfigured, events pertaining to any applicable application. Module 205 may further be made aware of events pertaining to remote computing devices, for example, information received over a network connection. For example, module 205 installed on computing device 105 may detect an arrival of information from a remote computing device, e.g., computing device 125. Such information may possibly be destined to apparatus 110. Alternatively, module 205 may detect that an update for an operating system is available from a vendor, or any other updates, possibly for a predefined list of applications.

According to embodiments of the invention, module 205 may detect or otherwise be aware of events such as activating an application, accessing information, or any other suitable event. For example, events comprising reference to a storage device may be communicated to module 205 or detected by module 205 as well as events such as activating a web browser, logging onto to an internet site, operating an internet protocol (IP) phone. According to embodiments of the invention, such events may be detected by detecting an invocation of a device driver. For example, an invocation of a device driver handling a hard disk drive, a device driver handling a removable media drive, a device driver handling a network interface card (NIC) or any device driver handling a device or interface that may be associated with stored, or otherwise accessible information. According to embodiments of the invention, module 205 may further detect user interaction idle time or inactivity periods, for example by tracking events such as, but not limited to, mouse movement or clicks, keyboard key presses or an activation of a screen saver. According to embodiments of the invention, module 205 may detect or otherwise be aware of a user login, module 205 may further identify the user currently logged onto a relevant computing device.

According to embodiments of the invention, module 205 may communicate with programs, procedures and/or applications being executed on a relevant device, e.g. computing device 105. According to embodiments of the invention, plug-ins, hooks or any other applicable means or methods may be used in order to extract or otherwise obtain information from various applications and/or operating systems processes or modules and further communicate such information to module 205. For example, a plug-in may be configured to extract or otherwise obtain information from an internet browsing application (web browser). Such plug-in may provide module 205 with any applicable information pertaining to an interaction of a user operating a web browser with an internet site. For example, module 205 may be provided by such plug-in with any content retrieved from a site by the browser as well as any actions or interactions performed by a user in association with the browser and/or an internet site.

Other examples of applications with which plug-ins or other means may be associated such that module 205 may be provided with relevant information may be instant messaging (IM) applications such as MSN Messenger™, Windows Live Messenger™, AOL Instant Messenger™ (AIM), Yahoo Messenger™, ICQ™, etc. According to embodiments of the invention, module 205 may be provided by means such as described above with any information pertaining to sessions of such messaging applications. For example, any text exchanged between users of such applications may be made available to module 205 as well as any other content, metadata and/or information applicable and/or exchanged. For example, user identification, location, icons, files, audio and/or video clips, invitations or metadata associated with content exchanged.

According to embodiments of the invention, module 205 may extract any information or content from data provided to it by plug-ins or other means. For example, module 205 may be notified upon an event comprising an arrival of a message over an instant messaging (IM) session. According to embodiments of the invention, module 205 may further be provided with the content of the message. According to embodiments of the invention, module 205 may analyze the text in order to determine further actions. According to embodiments of the invention, module 205 may ignore an event, possibly according to additional information or module 205 may extract some information provided to it and further communicate such information to other components of embodiments of the invention.

According to embodiments of the invention, module 205 may further be configured to detect events caused by apparatus 110. For example, pressing a button installed on apparatus 110 as described above may communicate information to computing device 105 and may further cause an event in computing device 105. Such event may be detected by module 205. According to embodiments of the invention, module 205 may further extract, receive or otherwise obtain information associated with such detected event. For example, apparatus 110 may cause an event and may further attach information to such event. Accordingly, module 205 may detect such event and may further obtain associated information. Such configuration may enable embodiments of the invention to allow apparatus 110 to communicate with components of the invention such as personality module 210 or context module 215 described below.

According to embodiments of the invention, module 205 may further be a source of an event and/or information. For example, module 205 may create and communicate a periodic time event. According to embodiments of the invention, such periodic event may serve as a heart beat to various components of embodiments of the invention, for example, components or states that may evolve according to time.

According to embodiments of the present invention and as shown by block 215, embodiments of the invention may comprise a context module. According to embodiments of the invention and as shown by FIG. 2, context module 215 may receive information from event detection and information extraction module 205 and may further provide information and/or output to personality module 210 and/or to command dispatching and content communication module 220. According to embodiments of the invention, context module 215 may compute, derive, deduce and/or otherwise determine a context or a context parameter. According to embodiments of the invention, a context or context parameter may be computed, derived, deduced and/or determined according to any applicable information such as, but not limited to, information pertaining to a user operating the relevant computing device, environmental aspects such as noise level or temperature, a day of the week, an hour of the day, a location and/or applications being executed by, or on behalf of, a user logged into the relevant computing device. For example, a context or context parameter determined by embodiments of the invention at 01:00 AM on a cold and quiet Tuesday may be different than the context or context parameter computed and/or determined on a warm, noisy, Friday evening when a cheerful track of music is being played by an application executing on the relevant computing device.

According to embodiments of the invention, user behavioral aspects may be taken into account by module 215 in order to compute a context or context parameter. For example, the speed and manner by which a user is typing on a keyboard may be used as an indication of the user's mood, frame or state of mind and consequently, may affect a context or context parameter. Such information may be collected by embodiments of the invention by receiving keyboard presses events from the operating system or by a sound sensitive device capturing the sound of a keyboard's keys being pressed. Another example of user behavioral aspects that may affect a context or a context parameter may be the speed and manner by which a user moves a point and click device.

According to embodiments of the invention, information pertaining to a context or a context parameter may further comprise information pertaining to a remote user. For example, information and/or aspects such as described above pertaining to a remote user involved in, or otherwise associated with, a session associated with the relevant computing device may be taken into account by module 215 when computing a context or a context parameter. Such remote user may be, for example, a user exchanging information with a local user over an IM application. For example, a time zone or location of such remote user may be used by module 215 when computing a context or a context parameter. According to embodiments of the invention, an identity of such remote user may also affect a context or a context parameter. For example, a context determined when chatting with a known, possibly close friend, using an IM application may be different from the context or a context parameter determined by embodiments of the invention when chatting as described above with an unknown remote user.

According to embodiments of the invention, information and/or content exchanged between a computing device and a remote computing device may affect a context or a context parameter. For example, module 215 may be provided with information and/or content exchanged between a user operating a local computing device and a remote user. For example, information exchanged over a session of an IM application or information or content exchanged by electronic mail. According to embodiments of the invention, such information may be processed by module 215 and may further affect the context or a context parameter computed and/or determined. For example, emoticons (symbols and/or icons used to convey emotional content) received by module 215 may affect a context or a context parameter determined. Music content exchanged may be another example of content that may affect context, for example, metadata associated with music or other multimedia content exchanged may be processed by module 215 and further affect a resulting computed context or a context parameter.

According to embodiments of the invention, text exchanged between a user operating a computing device and a remote user may be analyzed, parsed or otherwise processed in order to determine a context or a context parameter. According to embodiments of the invention, various levels of processing may be applied to such text in order to determine the context of a conversation thus conducted. According to embodiments of the invention, a context or a context parameter may be affected by text exchanged during an entire session, namely, the history of a session, or text exchanged in previous time may be taken into account by embodiments of the invention when computing a context or a context parameter. According to embodiments of the invention, context module 215 may compute a number of, possibly different, contexts and may further associate and/or apply one or more contexts according to various configurations, circumstances or other applicable parameters. For example, a specific context or a context parameter associated with each specific session selected from a number of sessions concurrently established by an IM application may be computed. Accordingly, possibly by determining the active window or by determining the remote user currently interacted with by a local user, a context or a context parameter may be applied and/or made effective. Additionally, a global context or a context parameter may be computed. According to embodiments of the invention, such global context or a context parameter may be in effect in addition to a specific context or a context parameter as described above. Such global context or a context parameter may be computed according to parameters that may affect circumstances or other parameters that may be applicable to all specific contexts described above.

It should be noted that module 215 may be assisted by additional applications, programs, software, hardware, firmware or any other applicable utilities or means in order to determine a context or a context parameter. For example, third party applications may be provided with information obtained by module 215. Such applications may perform various computations and may further provide module 215 with results and/or output. It should further be noted that the list of parameters, information types and/or content used by module 215 in order to compute or derive a context or a context parameter as described above is by no means exhaustive. According to embodiments of the invention, module 215 may further be broken down to a number of sub-modules.

According to embodiments of the present invention and as shown by block 210, embodiments of the invention may comprise a personality module. According to embodiments of the invention and as shown by FIG. 2, module 210 may receive information from event detection and information extraction module 205 and from context module 215. According to embodiments of the invention and as shown by FIG. 2, module 210 may further provide information and/or output to module 220. According to embodiments of the invention, personality module 210 may be provided with a personality definition.

According to embodiments of the invention, a personality definition may comprise definitions of behavioral, temperamental, emotional and/or any other mental and/or physical conditions, aspects, characteristic, traits or qualities. According to embodiments of the invention, such information may characterize a unique, individual entity. According to embodiments of the invention, exemplary aspects of a personality may be manners, habits, tastes and/or moral characteristics and aspects. According to embodiments of the invention, aspects pertaining to physical state and/or conditions that may be included in a personality definition may be a tiredness level, a pain level, a stiffness level and/or other health or physical conditions. Exemplary aspects, characteristic, traits or qualities included in a personality definition may further be: nervousness, edginess, jumpiness, calmness, openness, extraversion, agreeableness, neuroticism, cheerfulness, contentment or sadness level. According to embodiments of the invention, a personality definition may comprise initial values that may be assigned to various aspects, characteristics and/or traits described above.

According to embodiments of the invention, a personality definition may further associate some or all of the aspects, qualities, characteristics and/or traits comprising the personality with a respective parameter set. According to embodiments of the invention, such parameter set may comprise a range parameter, a positive change pace parameter and a negative change pace parameter. For example, a personality definition may comprise an aspect of nervousness. Such nervousness aspect may further be associated with a parameter set comprising a high positive change pace, a low negative change pace and a range from zero (0) to ten (10), where zero may denote complete calmness and ten may denote a very high level of nervousness. Accordingly, such personality may be capable of becoming very nervous very quickly or easily and may further take long to calm down. Changing some parameters associated with the above nervousness aspect, for example, changing the range to be from three (3) to five (5) may produce a personality that may be incapable of becoming very nervous nor capable of being completely calm. Alternatively, altering the above parameter set to a range from zero (0) to three (3), a very low positive change pace and a very high negative change pace may produce a personality that is very hard to agitate (due to the very low positive change pace), may never reach a high level of nervousness (since it is limited by 3) and calms down quickly (due to the very high negative change pace).

According to embodiments of the invention, various other parameters may be defined or included in a personality definition. For example, parameters defining the effect of specific events, contexts, users, or information on specific aspects, qualities or specific traits of a personality may be defined. For example, an edginess quality included in a personality definition may be configured to react in a specific way to specific events, contexts or information. For example, edginess may be configured to rise when a session with a specific user is established in a IM application or when a specific person, e.g., mom is present near an embodiment of the invention. According to embodiments of the invention, such configuration may be realized by adjusting the positive change pace associated with edginess quality according to specific conditions, events or context.

Another example of a parameter that may be associated with aspects of a personality may be a definition of the effect of a passage of time on various personality aspects or characteristics. Any such or other parameters, rules or policies may be defined without departing from the scope of the invention. Additionally, other ways of defining, maintaining and otherwise manipulating a personality and state may be used by embodiments of the invention. The term “personality” used in this patent application specification should be expansively and broadly construed to include any aspects, characteristic, traits or qualities and/or accompanying parameters as described above.

According to embodiments of the invention, information defining a personality as described above may be stored, communicated, modified, or otherwise be subjected to any operations applicable to digital information. For example, according to embodiments of the invention, information defining a personality may be stored in a file on a storage device. Such file may further be communicated, edited, deleted, loaded into an application or otherwise manipulated in any applicable way. According to embodiments of the invention, a personality may be stored on apparatus 110. Such configuration may enable a user to download or store one or more personalities from a first computing device onto an apparatus such as apparatus 110, detach such apparatus from the first computing device and further attach the apparatus to a second computing device and upload such personalities definitions from the apparatus to the second computing device.

According to embodiments of the invention, a personality may be defined according to information in multiple files. For example, specific traits or various behavioral aspects of a personality may be defined in respective specific files. Accordingly, a number of users may collaboratively co-author or otherwise compile a personality by each contributing their respective, possibly partial, definitions. For example, a group of users may produce their own, possibly shared personality by each contributing their respective personality aspects to a personality by each providing their respective definitions in respective files. According to embodiments of the invention, expressions, gestures, actions and/or other tangible output or feedback, possibly triggered, initiated, caused or otherwise associated with a personality may be defined in one or more files and/or any other applicable information or content objects. Accordingly, such expressions, gestures, actions and/or other tangible output or feedback associated with a specific personality may be defined and/or shared by a number of users. For example, a group of users may jointly define aspects such as laughter, tone of voice, language, mechanical motions or any other applicable gestures and/or actions that an apparatus, possibly associated with a possibly jointly defined personality, may perform.

According to embodiments of the invention, personalities may be edited or modified by a user. For example, a graphical user interface (GUI) application may be provided where by a personality definition and/or parameters may be created, modified, or otherwise manipulated. For example, slide bars may be provided by such GUI application whereby the level of parameters pertaining to a personality may be modified. Check boxes may further enable a user to include or omit various aspects, characteristic, traits or qualities in a personality definition. According to embodiments of the invention, such tool or application may enable a user to load one or more personality definitions and/or parameters and to further create a new personality based on loaded personality definitions and/or parameters. According to embodiments of the invention, such tool or application may further enable a user to save a personality and state definition, for example, on a hard disk or a USB memory stick or any other suitable storage.

According to embodiments of the invention, information defining a personality may be loaded into, or otherwise provided to module 210. For example, computing device 125 may store a number of personalities, possibly in a number of files, where each file or group of files may further contain information defining a personality. According to embodiments of the invention, information in such files may be provided to module 210. Accordingly, module 210 may process information and/or events, for example, information and/or events received from event detection module 205, according to one or more loaded personalities. Such personality or personalities may be designated as the active personality or personalities. According to embodiments of the invention, a personality may be designated as an active personality according to various parameters, circumstances, conditions, or any other applicable aspects. For example, a computer used by a number of users may store a respective number of personalities respectively associated with the users. For example, users may be defined by the operating system operating the computer, accordingly, when a specific user logs into the computer, the specific personality associated with that user may be provided to module 210 and may further be used by module 210 in order to process information as will be described below. Another example of designating a personality as an active personality may be a designation of a specific personality as active according to a context or a context parameter. For example, a first personality may be designated as active when a first remote user is with a local user, for example, over an IM application session. Accordingly, such designated active personality may be used in order to compute a state, mood and/or gestures and actions associated with various events. According to other embodiments of the invention, a second personality may be designated as active when a second remote user interacts with a local user.

According to other embodiments of the invention, module 210 may be provided with a personality definition over a network. For example, a personality definition may be downloaded from a remote server, for example, over the internet. Accordingly, such downloaded personality definition may be used by module 210. It should be noted that since a personality definition may be manipulated as digital content, e.g., a file, embodiments of the invention are not limited by the source or storage of such personality definitions. According to other embodiments of the invention, a copy, communication or transfer of a personality and/or state definition may be triggered or initiated by various ways and/or according to various parameters, conditions or events. For example, a personality from a remote computer may be communicated to a local computer upon an establishment of a session of an IM application. Accordingly, an apparatus associated with such communicated and received personality may act in a specific way according to the remote user being interacted with over such IM application. Alternatively, as described above, module 210 may be provided with a personality definition stored on an apparatus such as apparatus 110 in FIG. 1.

According to embodiments of the invention, a personality provided to module 210, for example when a user logs into a computer, may also define an initial state. According to embodiments of the invention, a state may be defined by a specific set of values respectively assigned to a specific set of personality aspects as described above. For example, a set of specific levels respectfully assigned to nervousness, edginess, jumpiness, calmness and openness may define a specific state or mood of such personality. As described above, a personality may define the way by which such aspects, characteristic, traits or qualities may evolve in accordance with events, information, time, context or a context parameter or any other applicable circumstances.

According to embodiments of the invention and as described above, a personality definition may comprise an initial set of such values. Alternatively, a state of a personality may be saved and/or stored with a personality definition. In such case, when module 210 is provided with a personality definition it may further be provided with the state saved. According to other embodiments of the invention, module 210 may be provided with a personality definition as described and may further be provided, possibly by a separate procedure, with a state to be associated with the personality. Such state may be provided by or from a source other than the source providing the personality definitions. For example, a user may provide a personality definition to module 210 and may further download a state from the internet and provide module 210 with such state. In such case, module 210 may associate the state with the already loaded personality and may further process information according to the applied state and the loaded personality definition.

According to embodiments of the invention, a state and/or other dynamic aspects of a personality may evolve according to various parameters. According to embodiments of the invention, a state may evolve or change according to various events, information, time, context or a context parameter or any other applicable aspect. According to embodiments of the invention, module 210 may manipulate, modify and/or change a state of a personality by, for example, modifying values assigned to aspects of a personality. For example, a state of personality may become more edgy or irritable due to a series of events. Such series of events may be, for example, a series of messages, possibly from a particular remote user, received by an IM application. Such exemplary evolution may be accomplished by, for example, increasing the value assigned to a nervousness aspect or quality of the state of a personality according to the number of messages received. Alternatively, the state may change according to time, for example, an agitated personality may calm down with time, for example, by decreasing the value assigned to a nervousness aspect of the state of the personality according to time, for example, according to heart beat events produced by module 205 as described above. According to embodiments of the invention, in a similar manner, environmental conditions such as noise, temperature or context may also cause a state to evolve.

According to embodiments of the invention, a state manipulated by module 210 may be affected by information received from apparatus 110. For example, an input device installed on apparatus 110 as described above may obtain and/or produce information that may be communicated to computing device 105. Such communicated information may be received by event detection and information collection module 205 and may further be provided to module 210 and/or module 215. Such configuration may enable embodiments of the invention to enable a user to affect a state of a personality by providing input to apparatus 110 or, alternatively, by providing input through an application (possibly a GUI application), as described below.

According to embodiments of the invention, module 210 may process information and/or events according to a specific state and personality definition and may further produce an output in accordance with that personality definition and in accordance with the state and/or mood of the personality. For example, the output of processing an event such as a shutdown of computing device 105 according to a “cheerful” personality or state may differ from the output of the same event (a shutdown) when the relevant state or personality is a “grumpy” one. Another example may be an output produced by module 210 in association with information such as text received by an IM application. According to embodiments of the invention, module 210 may receive, possibly from module 205, text, icons and/or any other content exchanged over an IM application session. Module 210 may further process such information in accordance with the current state and personality. Accordingly, an output produced by module 210 in association with a given text or content as described may differ according to the personality and further, according to the state of the personality. For example, a smiley ( [symbol] ) received and processed by module 210 may cause module 210 to produce an output reflecting happiness in accordance with a first personality and state but may cause module 210 to produce an output reflecting dismay when a second, possibly more neurotic personality or agitated state are applicable.

According to embodiments of the invention, output produced by module 210 may reflect levels of emotions and conditions. For example, a possible output produced by module 210 may be “happy”, “very happy” or “extremely happy”. According to embodiments of the invention, output produced by module 210 may reflect combinations of levels of emotions and physical conditions. For example, an output produced by module 210 may be “happy and shy” or “embarrassed, giggly and sleepy” or “extremely happy, impatient and in pain”. According to embodiments of the invention, output produced by module 210 may be provided to module 220 described below. According to embodiments of the invention, module 210 may process information and/or events according to a number of personality definitions or states. For example, module 210 may be configured to randomly or otherwise select between a number of personalities and states when processing information and/or events. Such configuration may produce, for example, an effect of a split personality. Accordingly, such configuration may produce different output to be produced in association with otherwise similar inputs, e.g., similar events.

According to other embodiments of the invention, output produced by module 210 may comprise commands to be performed by apparatus 110. According to such configuration, personality module 210 may compute an action to be performed by apparatus 110. For example, module 210 may compute a state based on input received as described above and may further compute or select an action to be performed by apparatus 110, for example, in order to reflect a newly computed state, a passage of time or any other applicable aspects.

According to embodiments of the present invention and as shown by block 216, embodiments of the invention may comprise one or more applications that may receive events and/or information from module 205 and may further communicate information to command dispatching and content communication module 220. For example, such application may receive content such as a video clip or an audio file and may further, possibly after applying various changes or modifications, communicate such content to module 220. Accordingly, module 220 may communicate such content to apparatus 110, and apparatus 110 may play, present or otherwise provide the content to a user. According to embodiments of the invention, an application such as application 216 may be invoked, supervised or otherwise managed by components of the invention. For example, module 210 may invoke and further manage application 216 in order to provide apparatus 130 with multimedia content from local storage or from the internet.

According to embodiments of the present invention and as shown by block 220, embodiments of the invention may comprise a command dispatching and content communication module. According to embodiments of the invention, module 220 may receive information from personality module 210 and from context module 215 and may further produce or communicate a command. According to embodiments of the invention, commands produced by module 220 may be executed by apparatus 110 or 130 described in reference to FIG. 1A and FIG. 1B above. According to embodiments of the invention, module 220 may produce, obtain or select a command in accordance with information received from modules 210 and 215. For example, module 220 may map information or input received from module 210 such as “happy” to one or more commands that may cause apparatus 110 to reflect happiness. Module 220 may further map information or input received from module 210 such as “extremely happy” to possibly other one or more commands that may cause apparatus 110 to reflect extreme happiness. According to other embodiments of the invention, rather than selecting a command according to received information module 220 may receive commands to be executed by apparatus 110 or 130. Accordingly, in such cases module 220 may not be required to select a command but may perform other and/or additional tasks such as described below.

According to embodiments of the invention, module 220 may be provided with configuration information that may enable it to map specific input received from modules 210 and 215 to a specific set of commands. Such, possibly alternative, configuration information sets may enable module 220 to operate a variety of apparatuses. For example, a configuration file may list all commands supported by a specific apparatus and may further provide information indicating possible meanings or impressions that may be produced when such commands are executed by an apparatus supporting, and/or associated with, such listed commands.

According to embodiments of the invention, module 220 may supervise the operation of apparatus 110. For example, module 220 may delay communicating a new command to the apparatus until a previous command has been executed. According to embodiments of the invention, module 220 may be further configured to avoid communicating to apparatus 110 commands that may be mutually exclusive. For example, a command to move a mechanical part upwards may be delayed until a previous command to move same part downward has completed. Such potentially contradicting or mutually exclusive commands may be a result of, for example, two consecutive inputs from modules 210 and/or 215. Another supervisory role that may be assumed by module 220 may be monitoring and managing the number of commands performed by apparatus 110 per a period of time.

According to embodiments of the invention, command dispatching module and content communication 220 may further filter, alter or otherwise manipulate input from personality module 210 according to input from context module 215. For example, various emotions or effects that may otherwise be commanded to be expressed or performed by apparatus 110 may be filtered out by module 220 according to context information received from module 215. For example, a loud expression of joy that would otherwise be commanded by module 220 based on input from module 210 may be avoided based on context information received from module 215, for example, when a soft, quite music track is being played. According to embodiments of the invention, such context information may be obtained by context module 215 by examining metadata associated with the music track played, such metadata may have been received by module 215 from event detection and information extraction module 205 as described above.

According to embodiments of the invention, module 220 may further communicate content to apparatus 110. For example, module 220 may be provided with content such as text, video, audio or any other applicable content and may further communicate such content to apparatus 110. Such configuration may enable embodiments of the invention to provide a user with content by means installed on apparatus 110. For example, an audio clip may be played by a speaker installed on apparatus 110 or a video clip may be presented by a display installed on or otherwise associated with apparatus 110.

According to embodiments of the present invention and as shown by block 222, embodiments of the invention may comprise a transformation module. According to embodiments of the invention, transformation module 222 may apply necessary, required and/or desirable transformations to information communicated to apparatus 110. For example, error correction information such as forward error correction (FEC) may be incorporated into or added to information communicated to apparatus 110. Other transformations that may be required to be performed by transformation module 222 may pertain to communication medium 106. 121, 122 and/or 126. For example, if the commands or other information communicated to apparatus 110 or apparatus 130 may be required to traverse a wireless medium then some modifications may be required to be applied to the information communicated. Yet another transformation that may be applied to commands, information or other content communicated to apparatus 110 may be an encryption. Such encryption may be required, for example, in order to protect user privacy, for example, when medium 106 is a wireless medium.

According to embodiments of the present invention and as shown by block 230, embodiments of the invention may comprise a communication system. According to embodiments of the invention, communication system 230 may comprise any components necessary in order to logically and/or physically communicate information to apparatus 110 or 130. According to embodiments of the invention, communication system 230 may comprise third party components, operating system components software components, hardware components and/or firmware components.

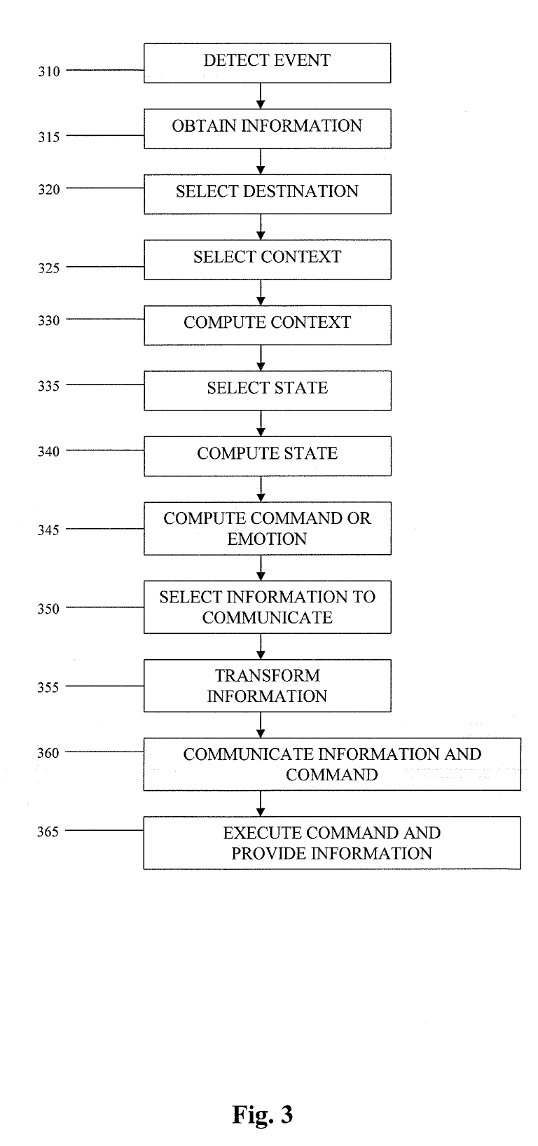

Reference is made to FIG. 3 showing an exemplary flowchart according to an embodiment of the present invention. According to embodiments of the invention and as shown by block 310, the flow may include detecting an event. For example, an event may be an arrival of information over a voice over internet protocol (VoIP) session, e.g., packets containing encoded speech data delivered to a VoIP application on a local computer. Such packets may be delivered to embodiments of the invention, for example by a plug-in associated with the VoIP application. According to embodiments of the invention, such plug-in may alert embodiments of the invention of an arrival of such packets and may further be configured to deliver the content of such packets and accompanying metadata, e.g., a source identification of the packets and/or any other relevant information. Another example of an event may be a scheduled meeting or event being reminded to a user by a calendar application. Yet another example of an event may be a termination of a download of content from an internet site or a termination of a copy of a file from a first location to a second location, for example, a copy of a file from an internal disk to a USB stick. Other examples may be a reception, over an IM application, of an invitation to join a session, a reception of a file over an IM application or any other applicable events. As described above, such events, as well as any other applicable software, hardware and/or firmware related events may be detected by embodiments of the invention.

According to embodiments of the present invention and as shown by block 315, the flow may include obtaining information pertaining or otherwise associated with a detected event. For example, speech data of a VoIP session may be obtained by embodiments of the invention. According to embodiments of the invention, specific segments of data may be obtained. For example, embodiments of the invention may extract various key words from an incoming electronic mail message, e.g., the sender name, the subject of the message etc. According to embodiments of the invention, text segments may be extracted from data exchanged over an IM application, such text segments may be used, for example, as input to a text-to-speech module as will be described below. Another example of obtaining or extracting data may be the obtaining of various parameters from an event initiated by an electronic calendar, for example, obtaining the time, location, duration and a list of attendees pertaining to a meeting. According to embodiments of the invention, specific keywords may be defined and, accordingly, such keywords may be searched for and/or extracted or may be used as guidelines for an extraction process.

According to embodiments of the invention and as shown by block 320, the flow may include selecting a destination for information, content and/or commands. According to embodiments of the invention, a single computing device such as computing device 105 in FIG. 1A may issue commands or provide content and/or information to one or more apparatuses such as apparatus 110 and, possibly additionally, to one or more computer applications. According to embodiments of the invention, commands, content and/or information may further be provided by embodiments of the invention to a computer application. Such computer application may be capable of presenting content to a user, for example by visual and audio effects (e.g., an attached display and attached speakers). According to embodiments of the invention, such computer application may present an animated graphical figure. For example, the animated figure may be a graphical representation of an apparatus, e.g., apparatus 110 or 130. According to embodiments of the invention, such application may retrieve information pertaining to an apparatus and further adjust various configurations accordingly For example, looks, gestures, actions or any other applicable parameters may be configured according to an attached apparatus. Alternatively, the application may enable a user to configure such parameters.

Such computer application may further be capable of receiving input from a user and further communicate such input to embodiments of the invention. For example, module 205 described above may be configured to receive information from such computer applications possibly in addition to receiving information from an apparatus such as apparatus 110. According to embodiments of the invention, a single event detected as described in reference to block 310 may cause embodiments of the invention to produce output to a number of apparatuses and/or applications. For example, an event may cause embodiments of the invention to issue one or more commands to an apparatus such as apparatus 110, provide content to an application being executed on the local computing device such as computing device 105 and further communicate content and/or commands to an application executing on a remote computing device such as computing device 125 or remote apparatus such as apparatus 130. According to embodiments of the invention, selection of a destination as shown by block 320 may affect further steps of the flow. For example, selection of a context and/or state as will be described below may be affected by a destination selection. According to embodiments of the invention, one or more destinations may be selected as shown by block 320. In such case, various steps, procedures or functionalities described below, for example, procedures and/or functionalities described with reference to blocks 325 to 365 may be repeated, possibly for each destination selected.

According to embodiments of the invention, any applicable information such as context, state, commands, personality definition and/or content may be communicated by embodiments of the invention to a remote computing device For example, a state may be communicated to a remote computing device by selecting an appropriate destination as shown by block 320. Commands, possibly to be executed by a remote apparatus, may be communicated to a remote computing device operatively connected to the remote apparatus by selecting the remote computing device as a target as shown by block 320. Such configurations may enable embodiments of the invention to share states, personalities, commands and/or any other information or content.

According to embodiments of the invention and as shown by block 325, the flow may include selecting a context or a context parameter. According to embodiments of the invention, a number of contexts may be maintained, for example, by context module 215 described above. According to embodiments of the invention, a context or a context parameter may be dynamically selected according to various parameters. For example, a context or a context parameter may be selected according to an identity of a remote user associated with an IM session, or a context or a context parameter may be selected according to a time of day or any other applicable information or parameters. Accordingly, a context or a context parameter may be selected according to the user operating the relevant computing device. According to embodiments of the invention, a context or a context parameter may further be selected according to a target device or application, for example, as selected as shown by block 320. According to embodiments of the invention, a first context or a context parameter may be associated with a first apparatus while a second context or a context parameter may be associated with a second apparatus or device.

According to embodiments of the present invention and as shown by block 330, the flow may include computing a context or a context parameter. According to embodiments of the invention, a context or a context parameter may evolve according to events and/or information. For example, a context or a context parameter may change according to emoticons received over an IM session or a context or a context parameter may evolve according to time progress even if no events are detected. According to embodiments of the invention, a context or a context parameter may evolve or change according to behavioral aspects of a user. For example, the frequency by which a user switches a focus between a number of application interfaces. According to embodiments of the invention, image processing and/or recognition possibly combined with voice processing and/or voice recognition may be used as input for manipulating a context or a context parameter. For example, a first context or a context parameter may be computed when a number of eight years old children are operating the relevant computer while a second context or a context parameter may be derived at when two seventy years old adults are present near the computer.

According to embodiments of the present invention and as shown by block 335, the flow may include selecting a state. According to embodiments of the invention, a state may be associated with a personality. Accordingly, a state may be associated, possibly by the association of a personality, with an apparatus or application. Accordingly, a state associated with the relevant apparatus or application may be selected. For example, possibly due to different personalities association, a first apparatus, e.g., apparatus 110 in FIG. 1A may be associated with a first state or mood while a second apparatus may be associated with a second, possibly different, state. According to embodiments of the invention, the selection of a state may be according to the target or destination apparatus or application selected as shown by block 320.

According to embodiments of the present invention and as shown by block 340, the flow may include computing a state. According to embodiments of the invention, and as described above, a state may evolve and/or change according to various information, events, conditions or other applicable parameters. According to embodiments of the invention, computing a state may comprise applying changes and/or modifications to a state according to, possibly newly, acquired information and according to the relevant personality. As described above, a personality definition may define an effect of various conditions, events and/or information on a state of that personality. Accordingly, definitions contained in the relevant personality, namely, the personality associated with the state, may be used in order to modify a state according to available information pertaining to events, conditions and/or content. According to embodiments of the invention, computing a state may further be according to a context or a context parameter, possibly a context or a context parameter as computed as shown by block 330. For example, a state or mood of a personality may be affected by the relevant context or a context parameter, e.g., a state may tend to be calmer when the context is one of an unfortunate nature.

According to embodiments of the present invention and as shown by block 345, the flow may include computing one or more commands and/or emotions. According to embodiments of the invention, commands to be communicated to, and further executed by a relevant apparatus or application may be computed. According to embodiments of the invention, such commands may be computed according to a context or a context parameter and/or state, possibly computed as shown by blocks 330 and 340 respectively. According to embodiments of the invention, commands may be computed such that movements, tangible actions and/or gestures applicable to the context, state and/or an event are produced and/or expressed by the relevant apparatus or application.

According to embodiments of the invention, gestures and/or actions performed and/or emotions expressed by an apparatus may be according to an intensity of an emotion. For example, an emotion such as anger may be quantified by embodiments of the invention, for example, anger may be expressed according to levels representing angry, very angry and furious. Such quantification may be performed, for example by personality module 210 described above when module 205 is configured to produce information describing an emotion. Accordingly, module 205 may produce information representing one such level of anger. Such information may be used to compute commands that express a correct level of anger as shown by block 345. According to embodiments of the invention, a level or intensity of an emotion may further be altered according to a context or a context parameter. Such alteration may be performed by module 205 when module 205 is configured to receive information pertaining to a context, for example from context module 215. Alternatively, modification of an emotion to be expressed may be performed by command dispatching module 220 as part of a command selection process, for example, command selection as shown by block 345.

According to embodiments of the invention, possibly in addition to commands destined to an apparatus such as apparatus 110 or apparatus 130 and/or commands destined to an application as described above commands to be executed by any applicable software entity may be selected or computed by embodiments of the invention. For example, commands to an operating system operating the relevant computing device or any other application may be selected and issued by embodiments of the invention. For example, commands to manipulate devices and/or peripherals attached to the computing device such as a display or speakers may be issued. Accordingly, an enthusiastic and happy personality may present funny images on a display, while an agitated, neurotic personality, may threaten to disconnect a network connection, terminate an application or shutdown a computing device, and according to embodiments of the invention, if not soothed in a timely manner, may indeed carry out such threats.

According to embodiments of the invention, commands computed as shown by block 345 may be according to the type or other applicable parameters pertaining to the target apparatus or application. For example, an apparatus may be configured to express various emotions according to a set of mechanical, electrical or other attributes, parameters and/or constraints. Accordingly, commands computed as shown by block 345 may be based on a specific configuration of a given apparatus. For example, a device may be fitted with one of a number of output devices, e.g., speakers, displays, lights or smart cover panels. Additionally, an apparatus may be equipped with capabilities such as text-to-speech, voice imitation or any other capabilities that may be realized by means such as, but not limited to, software, hardware, firmware and/or mechanical means. According to embodiments of the invention, commands computed as shown by block 345 may be according to capabilities, parameters, configuration or any other information pertaining to the target device or application.

According to embodiments of the invention, various emotions may be expressed in various ways. For example, various laughter sounds may be produced in order to express joy. According to embodiments of the invention, computing of commands as shown by block 345 may introduce a level of variance to gestures, actions and/or emotion expressions produced by an apparatus such as apparatus 130. For example, embodiments of the invention may alternate a laughter sound or any other expression made by an apparatus or application. Such alternation or introduction of variability of expressions may be performed by selecting appropriate commands.

According to embodiments of the present invention and as shown by block 350, the flow may include selecting information to communicate. According to embodiments of the invention, content such as music or other audio content, video or any other applicable multimedia content may be communicated to an apparatus such as apparatus 110 or to an application. According to embodiments of the invention, selecting content to be communicated may be subject to considerations and/or constraints similar to those described above in association with a selection of commands. For example, content containing a video clip may not be provided to an apparatus lacking a capability to present such content. According to embodiments of the invention, usage and/or capacity of resources available to the target apparatus may also be taken into account. For example, if an audio content is currently being provided to a user by the apparatus or application then embodiments of the invention may refrain from communicating a second audio content object to the apparatus or application.

According to embodiments of the invention, additional information or content to be communicated to an apparatus or application may be selected according to parameters such as an event, a context, a state or obtained information. For example, an event may comprise a user surfing to a web site, additional information that may be obtained by embodiments of the invention may be the content presented in such web site. According to embodiments of the invention, such content may further be analyzed. Possibly according to such analysis, information may be added by embodiments of the invention. For example, an audio clip commenting on the content presented in the web site may be communicated to an apparatus or application. Such audio clip may cause an apparatus to say (or ask) “Are you sure you should be watching this?” or “Wow, this is interesting stuff!”. Any applicable comments, gestures, actions or emotions expressed may be added by embodiments of the invention in such manner according to events, context or a context parameter and/or obtained information. Another example of information produced by embodiments of the invention may be in association with an answering machine application. For example, the event of an incoming call may be detected by embodiments of the invention. Embodiments of the invention may further intercept the operation of the answering machine application and may further provide the caller with an answer. Such answer may be according to a state and/or context or a context parameter as described above. For example, embodiments of the invention may provide a caller with an answer such as “Hello, my boss and I are in a foul mood, please be brief after the beep”. Other examples of adding content may be adding text to either incoming or outgoing electronic mail messages or textual conversations, e.g., when using an IM application, or adding voice clips to a VoIP conversation.

According to embodiments of the present invention and as shown by block 355, the flow may include transforming information. According to embodiments of the invention, information communicated to an apparatus or application may be transformed, converted or subjected to any manipulations either required or desired. For example, information to be presented to a user by an application may be converted to a format supported by the application. For example, a moving picture experts group Layer-3, also known as MPEG Layer-3, or simply MP3, audio content may be converted to waveform audio format (WAV) if the relevant apparatus has better support for such format. Other conversions, additions or transformations and/or modifications may be applied to information communicated to an apparatus or application, for example, in order to support error correction and/encryption as described above.

According to embodiments of the invention and as shown by block 360, the flow may include communicating commands and information to an apparatus or application. According to embodiments of the invention such communication may be performed according to applicable means and in accordance with the infrastructure facilitating a communication with the target apparatus or application.

According to embodiments of the invention and as shown by block 365, the flow may include executing commands and providing information to a user. According to embodiments of the invention, executing commands by an apparatus such as apparatus 110 may cause the apparatus to perform gestures, actions and/or convey or express emotions. Such gestures, actions or expression of emotions may be achieved by an execution of one or more commands. For example, one or more commands may cause an apparatus to laugh, wave its arms and waddle while another command or set of commands may cause an apparatus to flicker or close its eyes and mutter or mumble. According to other embodiments of the invention, execution of commands may comprise composite and/or advanced tasks such as applying text-to-speech technology to text and further providing a user with audible version of textual information or applying various image processing technologies to pictures or video clips and further providing a user with resulting graphic content.

According to embodiments of the invention and as described above, event detection as shown by block 310 of FIG. 3 or as described in association with block 205 of FIG. 2 may comprise detecting of any detectable event. According to embodiments of the invention, a target or destination selection as described with reference to block 320 may comprise selecting an apparatus or application that may be within considerable geographic distance, for example, such target apparatus or application may be associated with a remote computing device and accordingly, communication system shown by block 230 in FIG. 2 and/or communication of commands and information as shown by block 360 in FIG. 3 may comprise communicating information over a network such as network 120 in FIG. 1A, for example, the internet. Such configurations may be made possible by, for example, configuring event detection module 205 to detect events comprising an arrival of information communicated from a remote embodiment of the invention. Such configuration may further be made possible by configuring communication system 230 to communicate information to a remote embodiment of the invention. According to other embodiments of the invention event detection module 205 may be configured to communicate detected events to a remote computer.

Such configuration may enable both a local apparatus and/or application and a remote apparatus and/or application to react to events detected on the local computing device. Accordingly, embodiments of the invention may enable an apparatus to produce output, display emotions and/or act according to events, context or a context parameter and/or information pertaining to a remote computer. For example, an apparatus may react to events that are detected on a remote computer. An apparatus or application may further act and/or express emotions according to a context or a context parameter pertaining to a remote computer and/or remote user. For example, users chatting over an IM session may configure their local apparatus to behave according to the context or a context parameter, state and any other applicable information pertaining to the apparatus of their chat partner. According to embodiments of the invention, a personality may be communicated as described above. Accordingly, users may further obtain a personality associated with the remote apparatus and thus, provided with the remote personality, remote context or a context parameter, remote events and any other applicable information, users may effectively duplicate a remote apparatus locally.

According to embodiments of the invention, a possibly graphical user interface (GUI) application may be provided where by a user may interface with embodiments of the invention. For example, such interface application may provide a user with information such as the state or mood of an apparatus, the context currently applicable, a list of events detected or any other applicable information. According to embodiments of the invention, such interface application may further enable a user to manage, control or otherwise interact with an apparatus and/or a personality or a state. For example, such interface application may enable a user to cause an apparatus to stop or start functioning. Such interface application may further enable a user to configure various aspects or parameters. For example, such interface application may enable a user to configure and/or alter a context or a context parameter, a state or mood, or select and apply a context or a context parameter, personality or state to embodiments of the invention. According to embodiments of the invention, such interface application may further be incorporated into other application. For example, a GUI version of the interface application described above may be incorporated into a GUI of an existing application, for example, an IM application, email application or a web browsing application.

According to embodiments of the invention, such interface application may perform functionalities described above while executing on a remote computer. For example, such interface application may be made a part of a blog (short for Web Log, a journal kept on the internet) thus enabling surfers to view and/or control various aspects of a local apparatus, e.g., state, mood or context. According to embodiments of the invention, such configuration may further enable users to interact with a remote apparatus. For example, an interface incorporated in a blog as described above may enable surfers to tickle a remote apparatus. Accordingly, an apparatus may giggle when tickled and possibly inform a local user who tickled it or provide various other information applicable to such event. According to embodiments of the invention, any other applicable interface with a remote apparatus and or embodiment of the invention may be supported by appropriately configuring embodiments of the invention.

Embodiments of the invention may be configured such that an apparatus such as apparatus 110 may interact with an application. For example, such application may be an application presenting, possibly on an attached display, an animated figure as described above. According to such configuration, apparatus 110 and an animated figure may exchange comments, for example pertaining to content viewed in a web site or music being played. Alternatively, apparatus 110 and an animated figure may argue, joke or perform any applicable activities. According to embodiments of the invention, different personalities may be associated with the apparatus and the animated figure thus possibly enhancing the impression of the interaction. Alternatively, apparatus 110 may interact in the same manner described above with another, remote or local apparatus, e.g., apparatus 130.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A system comprising:
a personality module capable of being executed on a computing device, said personality module when executed is to receive information and to further compute a personality state according to said information and according to a personality definition; and
an apparatus operatively connected to said computing device to perform at least one tangible action according to the personality state computed by said personality module.

2. The system of claim 1, further configured to transmit and receive a personality definition to and from a remote computing device respectively.

3. The system of claim 1, further configured to transmit and receive a personality state to and from a remote computing device respectively.

4. The system of claim 1, wherein said personality module is further configured to select at least one personality definition according to an identification of a user operating said computing device.

5. The system of claim 1, further comprising a computer application capable of being executed on said computing device to produce an output according to said computed personality state.

6. The system of claim 1, further comprising a context module to compute a context parameter according to received information, wherein said personality module is further to compute said personality state according to a context parameter.

7. The system of claim 6, wherein said context module is further configured to compute said context parameter according to information exchanged between said computing device and at least one other computing device.

8. The system of claim 6, further configured to transmit and receive said context parameter to and from a remote computing device respectively.

9. The system of claim 6, wherein said context module is further configured to determine a context according to information collected from at least one device selected from a group consisting of: an audio sensing device, a light sensing device, a mechanical device, a pointing device, a keyboard, a heat sensing device, a pressure sensing device, a scent sensing device, a time measuring device, and a motion detection device.

10. The system of claim 6, further comprising a computer application capable of being executed on said computing device to produce an output according to said context parameter.

11. The system of claim 6, further comprising an event detection module to detect at least one event, wherein said context module is further configured to compute said context parameter based on said detected event.

12. The system of claim 1, further comprising a context module to compute a context parameter according to received information, and to further cause said apparatus to produce said at least one tangible action according to said context parameter.

13. The system of claim 1, further configured to receive a context parameter from a remote computing device, wherein said personality module is further to compute said personality state according to said received context parameter.

14. The system of claim 1, further comprising an event detection module to detect at least one event, wherein said personality module is further to compute said personality state according to said detected event.

15. The system of claim 14, wherein said event detection module is further configured to receive information pertaining to an event from at least one application.

16. The system of claim 14, wherein said event detection module is further configured to receive information pertaining to events from at least one input device operatively connected to said computing device.

17. The system of claim 16, wherein said at least one input device is selected from the group consisting of: an audio sensing device, a light sensing device, a mechanical device, a point and click device, a keyboard, a heat sensing device, a pressure sensing device, a scent sensing device, a time measuring device, and a motion detection device.

18. The system of claim 14, wherein said event detection module is further configured to detect at least one event associated with a remote computing device.

19. The system of claim 1, wherein said apparatus is further equipped with at least one input device selected from the group consisting of: an audio sensing device, a light sensing device, a heat sensing device, a scent sensing device, a pressure sensing device, and a motion sensing device.

20. The system of claim 1, wherein said at least one tangible action is at least one tangible action selected from the group consisting of: a mechanical motion, a visual effect, and an audible effect.

21. The system of claim 1, wherein said apparatus is further configured to communicate with said computing device over a wireless communication medium.

22. A method comprising:
receiving information at a computing device;
computing a state of a personality according to said information and according to a personality definition; and
performing based on said computed state of a personality at least one tangible action by an apparatus operatively connected to said computing device.

23. The method of claim 22, further comprising transmitting and receiving a definition of said personality to and from a remote computing device respectively.

24. The method of claim 22, further comprising transmitting and receiving a state of a personality to and from a remote computing device respectively.

25. The method of claim 22, further comprising selecting least one personality definition according to an identification of a user operating said computing device.

26. The method of claim 22, further comprising performing based on said computed personality state at least one tangible action by a computer application capable of being executed on said computing device.

27. The method of claim 22, further comprising computing a context parameter according to received information, and further computing a state of a personality according to said context parameter.

28. The method of claim 27, further comprising computing said context parameter according to a communication between said computing device and at least one other computing device.

29. The method of claim 22, further comprising transmitting and receiving a context parameter to and from a remote computing device respectively.

30. The method of claim 27, further comprising determining said a context parameter according to information collected from at least one device selected from a group consisting of: an audio sensing device, a light sensing device, a mechanical device, a pointing device, a keyboard, a heat sensing device, a pressure sensing device, a scent sensing device, a time measuring device, and a motion detection device.

31. The method of claim 27, further comprising producing an output according to said context parameter by a computer application.

32. The method of claim 27, further comprising detecting at least one event, and further comprising computing said context parameter based on said detected event.

33. The method of claim 27, further comprising performing said at least one tangible action according to said context parameter.

34. The method of claim 22, further comprising receiving a context parameter from a remote computing device, and further computing a state of a personality according to said received context parameter.

35. The method of claim 22, further comprising detecting at least one event, and wherein said computing said state of a personality is according to said at least one detected event.

36. The method of claim 35, wherein said detecting at least one event further comprises receiving information pertaining to an event from at least one application.

37. The method of claim 35, wherein said detecting at least one event further comprises receiving information pertaining to an event from at least one input device operatively connected to said computing device.

38. The method of claim 37, wherein said at least one input device is selected from the group consisting of: an audio sensing device, a light sensing device, a mechanical device, a point and click device, a keyboard, a heat sensing device, a pressure sensing device, a scent sensing device, a time measuring device, and a motion detection device.

39. The method of claim 35, wherein said detecting at least one event further comprises detecting at least one event associated with a remote computing device.

40. The method of claim 22, wherein said at least one tangible action is selected from the group consisting of: a mechanical motion, a visual effect, and an audible effect.
